(19) United States
(12) Patent Application Publication
(10) Pub. No.: US 2007/0240801 A1
(43) Pub. Date: Oct. 18, 2007

(54) Pneumatic Tire

(75) Inventor: Masaya Tanaka, Osaka (JP)

Correspondence Address: FISH & RICHARDSON P.C., P.O. BOX 1022, MINNEAPOLIS, MN, 55440-1022, US

(73) Assignee: Toyo Tire & Rubber Co., Ltd., Osaka (JP)

(21) Appl. No.: 11/695,901

(22) Filed: Apr. 3, 2007

(30) Foreign Application Priority Data
Apr. 18, 2006 (JP) 2006-115028

(51) Int. Cl. B60C 11/13

(52) U.S. Cl. 152/209.21

(57) ABSTRACT

A pneumatic tire capable of preventing clogging of a groove on a tread to improve snow performance and mud performance is provided. The pneumatic tire includes a tread having a land area such as a block and a rib sectioned by a groove formed on a tread surface, and an edge disposed on a side of the land area, which edge extends from a land surface to a groove bottom and projects into the groove. The edge has a bent portion having an obtuse angle and thus is step-shaped in the depth direction of the groove.

### CROSS-REFERENCE TO RELATED APPLICATIONS

This application is based upon and claims the benefit of priority from the prior Japanese Patent Application No. 2006-115028, filed on Apr. 18, 2006; the entire contents of which are incorporated herein by reference.

### BACKGROUND OF THE INVENTION

1. Technical Field

The present invention relates to a pneumatic tire, and more particularly to a structure of a pneumatic tire capable of preventing clogging of a groove on a tread.

2. Related Art

There is a demand for improvement over snow performance such as braking, accelerating, and turning abilities of a winter tire such as a studless tire on a snow road. For the improvement of the snow performance, a tire known in the art has zigzag-shaped sides of blocks and a rib on a tread, for example, to provide additional edges on the sides so that sufficient traction effect can be obtained (see, U.S. Pat. No. 5,386,861 (corresponding to JP-A-5-238211) and WO2002/043972).

The tire having the zigzag portions of the blocks and rib offers snow performance improved to some extent. According to the zigzag-shaped structure in the related art, however, grooves dividing the blocks and rib are easily clogged with snow. This clogging by snow decreases the traction effect by half.

A structure disclosed in JP-A-2002-36822 has a plurality of projections on side walls of grooves. However, the technology shown in this reference is aimed at improvement over stone engagement prevention, which does not correspond to the object of the invention shown below. In addition, the structure of the reference constituted by the plural projections arranged in parallel in the groove depth direction is completely different from the characteristic structure of the invention.

### SUMMARY OF THE INVENTION

The reason why the above-mentioned zigzag-shaped structure is easily clogged with snow is now clarified.

FIG. 10 illustrates a block shape in a comparative example having the zigzag-shaped structure. Edges 104 provided on a side 101 of a block 100 extend from a block surface 102 to a groove bottom 103 and project into a groove. Two edges 104 are formed on one side 101 so that the side 101 can be zigzag-shaped. The edges 104 straight-linearly extend from the block surface 102 to the groove bottom 103 substantially in the vertical direction.

When the respective edges 104 are arranged substantially in the vertical direction, snow entering into the grooves has no escape route, as shown in FIG. 11, and therefore cannot easily move (snow movement directions are shown by arrows in the figure). The snow difficult to be discharged from the grooves easily clogs the grooves. Thus, the traction effect decreases by half due to the clogging snow, resulting in lowering of the snow performance.

Similarly to the clogging snow which decreases the snow performance, mud clogging the grooves lowers mud performance.

Accordingly, it is an object of the invention to provide a pneumatic tire having a tread structure which has edges and maintains sufficient traction effect by preventing clogging of a groove so that snow performance and mud performance can be improved.

A pneumatic tire according to the invention includes a tread having a land area sectioned by a groove formed on a tread surface, and an edge disposed on a side of the land area, which edge extends from a land surface to a groove bottom and projects into the groove. The edge has a bent portion having an obtuse angle and thus is step-shaped in the depth direction of the groove. The bent portion may be either a portion bent (cornered) such that a corner having an obtuse angle is formed, or a curved (rounded) portion having an obtuse angle.

According to the invention, the edge extending from the land surface to the groove bottom is provided on the side of the tread land area such as a block and a rib. The edge has the bent portion having the obtuse angle and thus is step-shaped in the depth direction of the groove. According to this structure, snow or mud having entered the groove easily moves due to the presence of the bent portion having the obtuse angle. In this case, the snow or mud is gradually discharged during rotation of the tire, and thus clogging of the groove is not caused. Accordingly, the traction effect is maintained, and the snow performance and mud performance are improved.

### BRIEF DESCRIPTION OF THE DRAWINGS

FIG. 1 illustrates a part of a developed tread pattern of a pneumatic tire in a first embodiment.

FIG. 2 is an enlarged perspective view illustrating a part of the tread in the first embodiment.

FIG. 3 is a perspective view of a block in the first embodiment.

FIG. 4 schematically illustrates a side of a block array during rotation of the tire on a snow surface in the first embodiment.

FIG. 5 is a perspective view of a block in a second embodiment.

FIG. 6 is a perspective view of a block in a third embodiment.

FIG. 7 schematically illustrates a side of a block array during rotation of the tire on a snow surface in the third embodiment.

FIG. 8 schematically illustrates a side of a block array during rotation of the tire on a snow surface in a fourth embodiment.

FIG. 9 schematically illustrates a side of a block array during rotation of the tire on a snow surface in a fifth embodiment.

FIG. 10 is a perspective view of a block of a tire in a comparative example.

FIG. 11 schematically illustrates a side of a block array during rotation of the tire on a snow surface in the comparative example.

### DESCRIPTION OF THE PREFERRED EMBODIMENTS

Embodiments according to the invention are hereinafter described with reference to the accompanying drawings.

### First Embodiment

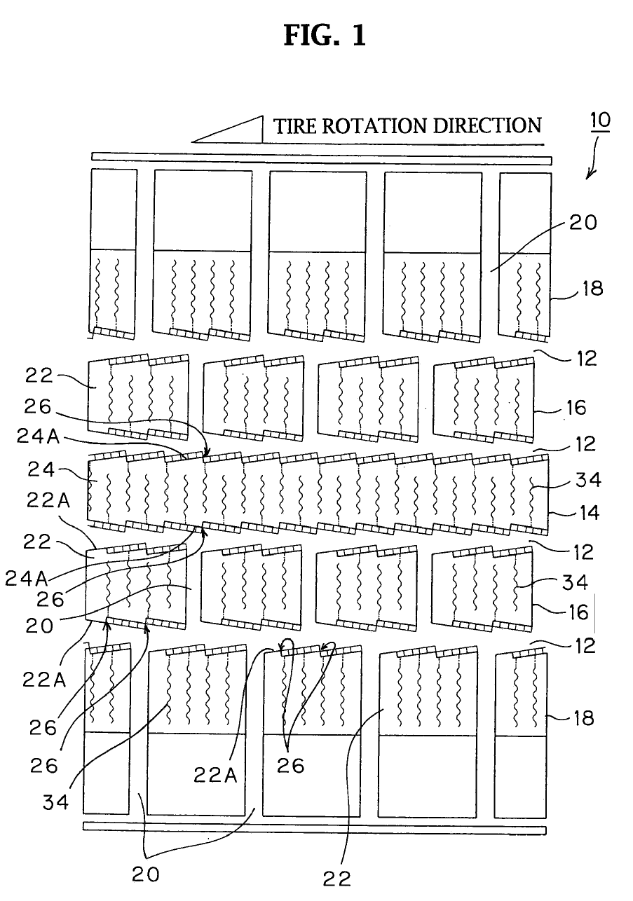

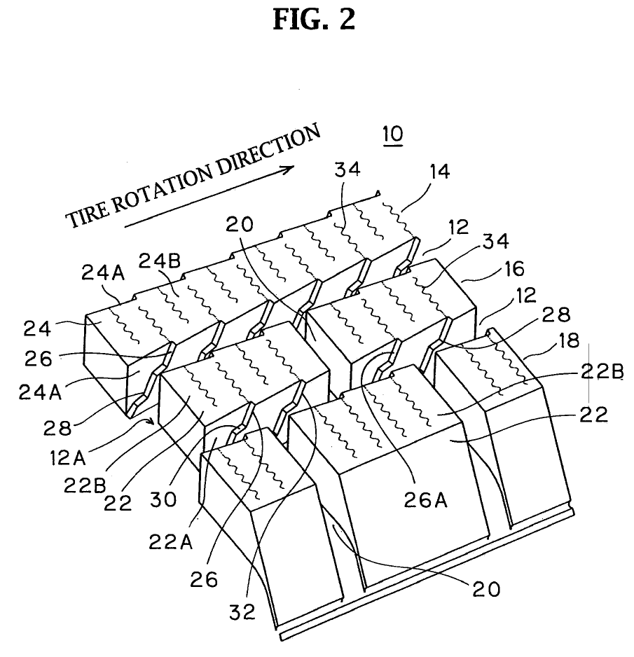

FIG. 1 is a plan view illustrating a part of a developed tread pattern of a pneumatic tire (studless tire) in a first embodiment according to the invention. FIG. 2 is an enlarged perspective view illustrating a part of the tread shown in FIG. 1. The tire has a plurality of circumferential grooves 12 extending in a tread circumferential direction (the number of the grooves 12 is four in this embodiment) on a tread 10. The circumferential grooves 12 divide the tread 10 into five regions of a center region 14, intermediate regions 16, 16 provided on both sides of the center region 14 such that the center region 14 is sandwiched between the intermediate regions 16, 16, and shoulder regions 18, 18 formed at both ends of the tread 10 outside the intermediate regions 16.

The intermediate regions 16 and the shoulder regions 18 have transverse grooves 20 arranged in parallel at predetermined intervals in the circumferential direction. The transverse grooves 20 extend in the tread width direction, and cross the circumferential grooves 12. Thus, the intermediate regions 16 and the shoulder regions 18 have block arrays having a number of blocks 22 sectioned by the circumferential grooves 12 and the transverse grooves 20 and arranged in line in the tread circumferential direction. The center region 14 has no transverse groove, and thus provides a rib 24 which is sectioned by the two circumferential grooves 12, 12 and continuously extends in the tread circumferential direction.

Each side of the blocks 22 and the rib 24 has a zigzag shape. More specifically, each of the blocks 22 in the intermediate region 16 has sides 22A, 22A facing the circumferential grooves 12, 12, and each of the sides 22A, 22A has a plurality of edges 26 (two edges 26 in this embodiment) extending from a block surface 22B to a groove bottom 12A and projecting into the corresponding groove 12 to have a step shape. Thus, both the sides 22A, 22A of the blocks 22 are zigzag-shaped. The similar edges 26 are formed only one of the sides 22A of the blocks 22 in the shoulder region 18 facing the corresponding circumferential groove 12 such that the side 22A having the edges 26 can be zigzag-shaped. The similar edges 26 are further formed on both sides 24A, 24A of the rib 24 in the center region 16 facing the circumferential grooves 12, 12 at predetermined intervals in the circumferential direction. These edges 26 on the sides 24A, 24A of the rib 24 extend from a rib surface 24B to the groove bottom 12A such that both the sides 24A, 24A are zigzag-shaped.

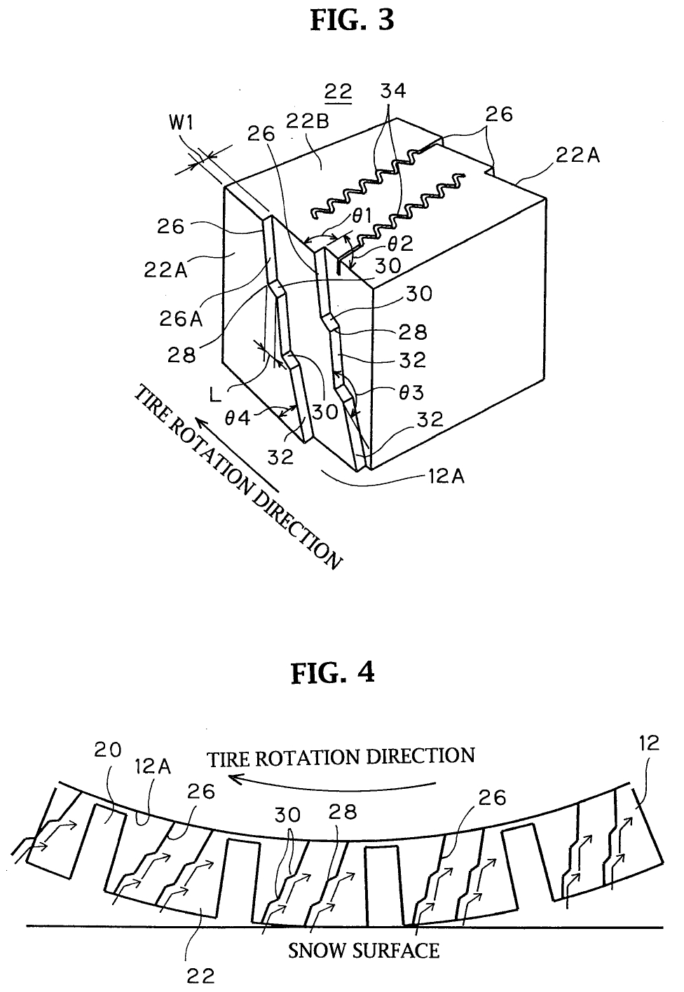

The edges 26 project from the block sides 22A and the rib sides 24A in directions substantially perpendicular to the block sides 22A and the rib sides 24A. More specifically, as illustrated in FIG. 3, each of step surfaces 26A constituting the edges 26 has approximately right angles θ1 and θ2 to portions of the side 22A positioned before and behind the step surface 26A. The projection amount, i.e., a width W1 of the step surface 26A is 1 mm or larger, which is kept substantially constant in the depth direction of the groove 12. The width W1 is sufficiently smaller than the space between the adjoining edges 26, 26. The edges 26 are formed such that the step surfaces 26A are directed to the rear in the tire rotation direction, i.e., in the direction opposite to the tire rotation direction.

As illustrated in FIG. 3, the edges 26 formed along the sides 22A are bent to provide bent portions 28 having obtuse angles, and thus the edge 26 are step-shaped in the depth direction of the circumferential grooves 12. More specifically, the edges 26 are step-shaped as viewed from the block sides 22A as front faces, and the bent portions 28 forming the respective steps of the step shapes have obtuse angles. In this embodiment, the bent portions 28 are sections formed by bending the step surfaces 26A of the edges 26 such that obtuse angles are formed, and these bent sections produce two steps 30, 30 on each of the step surfaces 26A in the groove depth direction. An angle θ3 of the bent portions 28 may be any angle within the range of obtuse angles (90°<θ3<180°), but preferably the angle θ3 is within the range from 120° to 160°. It is preferable that the steps 30 are inclined in the groove depth direction with respect to the block surface 22B rather than extend in parallel with the block surface 22B.

As illustrated in FIGS. 2 and 3, according to this embodiment, the edges 26 extend from the block surface 22B to the groove bottom 12A while inclined to the rear in the tire rotation direction. More specifically, each of the edges 26 has three inclined surfaces 32, 32, 32 inclined to the rear in the tire rotation direction, and the two steps 30, 30 each of which is interposed between the adjoining inclined surfaces 32. An inclined angle θ4 of the inclined surface 32 may be any angle in the range smaller than 90°, but preferably the angle θ4 is within the range from 50° to 80°. A length L of the steps 30 is preferably 1 mm or larger.

The edges 26 formed on the sides 24A of the rib 24 have the same structure as that of the edges 26 formed on the sides 22A of the blocks 22. The surfaces of the respective blocks 22 and rib 24 have sipes 34 extending in the tread width direction. The sipes 34 are cuttings having small width, and are wavy and zigzag-shaped in this embodiment.

According to the tire in this embodiment discussed above, the edges 26 forming the zigzag shapes of the peripheral sides of the blocks 22 and the rib 24 have steps formed by the bent portions 28 having obtuse angles in the depth direction of the grooves 12. Thus, as illustrated in FIG. 4, snow or mud having entered the grooves 12 easily moves due to the presence of the bent portions 28 having obtuse angles, particularly of the steps 30 having obtuse angles (movement directions of snow are indicated by arrows in the figure). In this case, the snow or mud is gradually discharged to the rear during rotation of the tire, and thus clogging of the grooves is not caused. As a result, snow performance and mud performance can be improved. Such a tire having edges 26 which are simply inclined does not sufficiently discharge snow or mud, probably because the snow or mud having entered the grooves 12 moves as a mass reaching the entire groove depth. In this case, excellent snow performance or mud performance achieved according to this embodiment is not obtained.

### Second Embodiment

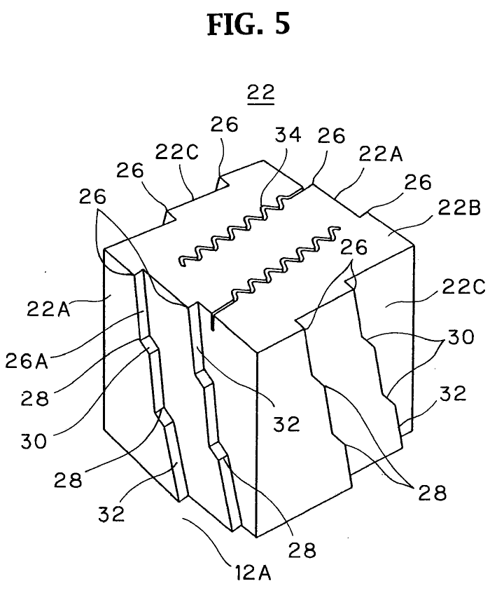

FIG. 5 is a block structure according to a second embodiment. In this embodiment, the edges 26 having a similar step-shaped structure as that of the edges 26 in the first embodiment are formed on all the sides of the blocks 22 such that all the sides have zigzag shapes.

Since the edges 26 are formed not only on the sides 22A facing the circumferential grooves 12 but also on sides 22C facing the transverse grooves 20, clogging of the transverse grooves 20 by snow or mud can be further prevented.

According to this embodiment, the edges 26 and the inclination of the step shapes of the edges 26 formed on the left side 22A facing the corresponding circumferential groove 12 are opposite to those on the right side 22A facing the corresponding circumferential groove 12. This structure is applicable to a tire whose rotation direction is not fixed. Similarly, the edges 26 and the inclination of the step shapes of the edges 26 formed on the front side 22C facing the corresponding transverse groove 20 are opposite to those on the rear side 22C facing the corresponding transverse groove 20. This structure provides excellent effect for preventing clogging of the transverse grooves 20 during turning to both the left and right.

Other parts are similar to those in the first embodiment, and similar operations and advantages are offered according to this embodiment.

### Third Embodiment

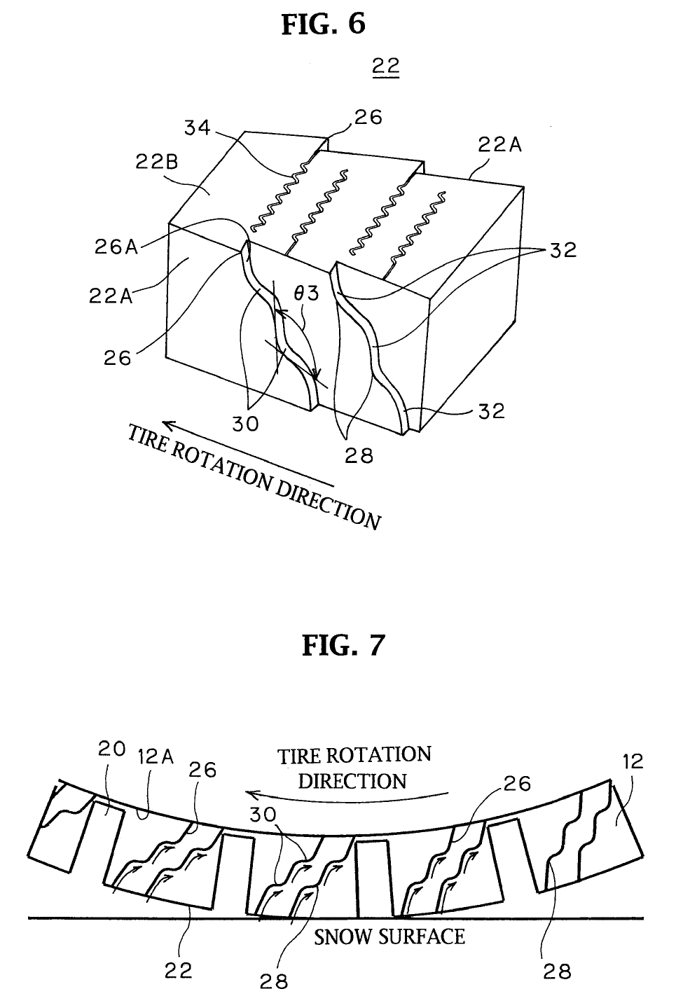

FIG. 6 is a block structure according to a third embodiment. In this embodiment, the step-shaped edges 26 have round and wavy shapes with no corners, unlike the cornered shapes in the first embodiment.

According to this embodiment, the edges 26 have bent portions 28 (curved portions) curved such that obtuse angles are formed, and thus the edges 26 have wavy step shapes in the depth direction of the grooves 12 as viewed from the block sides 22A as the front surfaces. The obtuse angles of the curved portions 28 herein refer to obtuse angles formed by linear portions when the linear portions are present above and below the curved portions 28, and obtuse angles formed by tangential lines of curvilinear portions above and below the curved portions 28 when the linear portions are not present.

Other parts are similar to those in the first embodiment. Similarly to the above embodiments, snow or mud having entered the grooves 12 easily moves due to the presence of the curved portions 28 having obtuse angles as shown in FIG. 7, particularly of the steps 30 (movement directions of snow are indicated by arrows in the figure). In this case, the snow or mud is gradually discharged to the rear during rotation of the tire.

### Fourth Embodiment

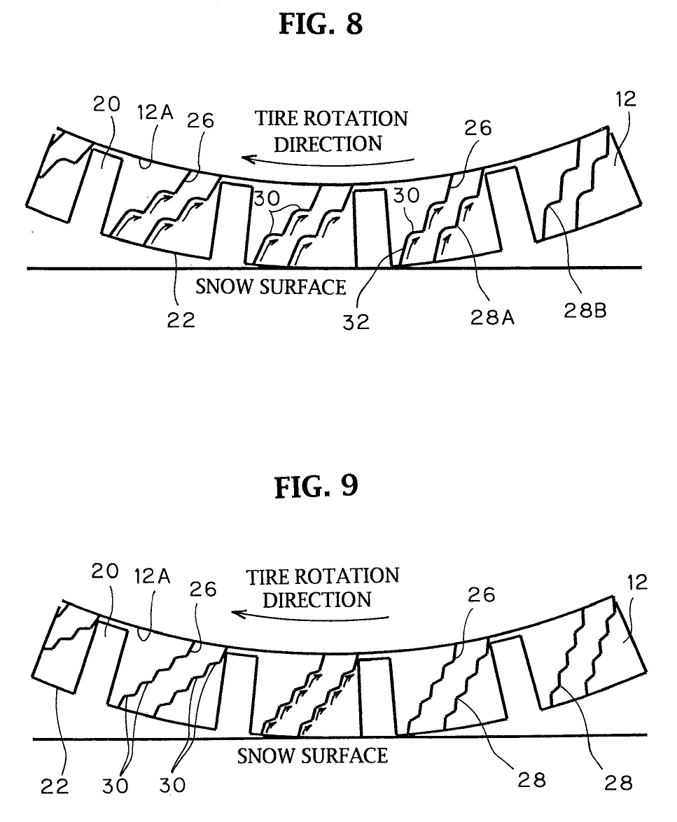

FIG. 8 schematically illustrates sides of a block array in a fourth embodiment during rotation of the tire on a snow road surface. The step shapes of the edges 26 in this embodiment have combined shapes of the edges 26 in the first and third embodiments.

According to this embodiment, the edges 26 have cornered portions 28A having obtuse angles and curved portions 28B having obtuse angles, and thus the edges 26 are step-shaped. Each of the curved portions 28B is disposed between an adjoining pair of the lower inclined surface 32 and the upper step 30, and each of the cornered portions 28A is disposed between an adjoining pair of the lower step 30 and the upper inclined surface 32.

Other parts are similar to those in the first embodiment. Similarly to the above embodiments, snow or mud having entered the grooves 12 easily moves due to the presence of the steps 30 having obtuse angles (movement directions of snow are indicated by arrows in the figure). In this case, the snow or mud is gradually discharged to the rear during rotation of the tire.

### Fifth Embodiment

FIG. 9 schematically illustrates sides of a block array in a fifth embodiment during rotation of the tire on a snow road surface. According to this embodiment, the number of the steps 30 of the step-shaped edges 26 is increased from that in the first embodiment, that is, four steps 30 are formed. As apparent, the number of the steps of the edges 26 may be any number in the range of one or larger. Other parts are similar to those in the first embodiment, and similar operations and advantages are offered according to this embodiment.

While the example of the tread pattern having the blocks 22 and the rib 24 has been discussed in the above embodiments, the invention is applicable to other types of tread patterns such as a tread pattern having only a block, and a tread pattern having only a rib. It is therefore possible to conclude that the structure of the edges 26 is applicable to a tread pattern including a block and/or a rib.

### EXAMPLE

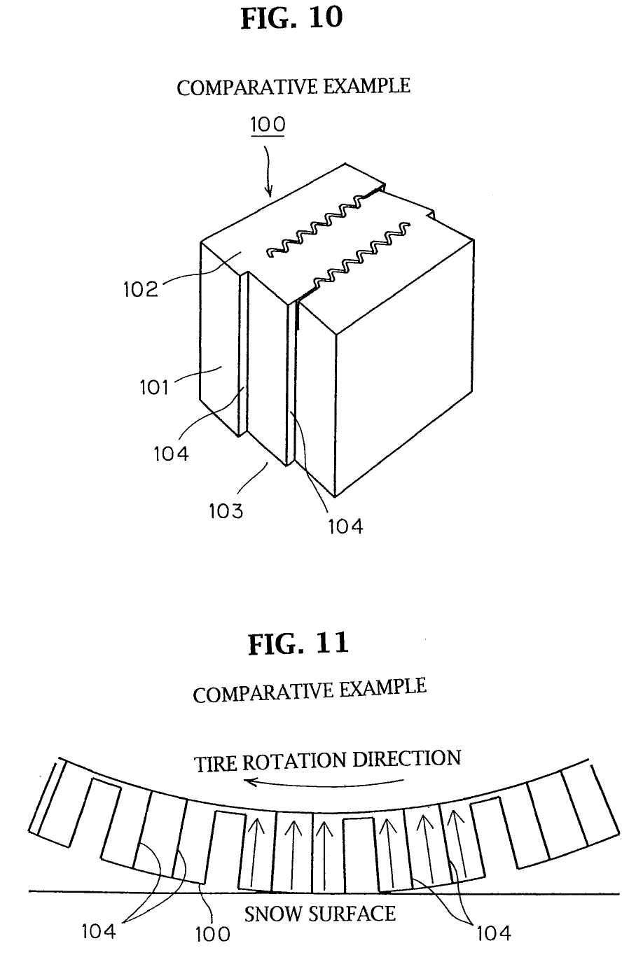

A pneumatic radial tire in the first embodiment (Example 1) and a tire in the comparative example having an edge structure shown in FIG. 10 and other parts similar to those in Example 1 (Comparative example 1), both of which tires have a tire size of 205/65R15, were prepared. The prepared tires were attached to an automobile having displacement of 3,000 cc (CROWN manufactured by Toyota, FR and AT vehicle, rim size: 15×6.5JJ), and snow braking and snow accelerating abilities were evaluated. The evaluation method is as follows.

Snow braking ability: the vehicle running on a snow road was ABS braked at the running speed of 40 km/h, and the braking distance was measured.

Snow accelerating ability: the stopping vehicle was accelerated in the L range on a snow road to adjust the engine revolution to 3,500 rpm. Then, the seconds required for the vehicle under 3,500 rpm to advance for the distance of 20 m was counted.

According to the results of Example 1, 10% improvements of both the snow braking ability and the snow accelerating ability from the results of Comparative example 1 were recognized. Thus, the snow performance was enhanced in Example 1.

Accordingly, the pneumatic tire of the invention is appropriately used particularly for a winter tire such as a studless tire and for an off-road tire which requires high mud performance. The invention is also applicable to various other types of pneumatic tires.

What is claimed is:

1. A pneumatic tire, comprising:
a tread having a land area sectioned by a groove formed on a tread surface; and
an edge disposed on a side of the land area, which edge extends from a land surface to a groove bottom and projects into the groove, wherein
the edge has a bent portion having an obtuse angle and thus is step-shaped in the depth direction of the groove.

2. The pneumatic tire according to claim 1, wherein the bent portion is a cornered portion having an obtuse angle.

3. The pneumatic tire according to claim 1, wherein the bent portion is a curved portion having an obtuse angle and thus is wavy in the depth direction of the groove.

4. The pneumatic tire according to claim 1, wherein the edge is disposed on a side which faces a circumferential groove extending in the tread circumferential direction.

5. The pneumatic tire according to claim 4, wherein the edge extends from the land surface to the groove bottom while sloping toward the rear with respect to the tire rotation direction.

6. The pneumatic tire according to claim 1, wherein a plurality of the edges are formed on the side of the land area so that the side can be zigzag-shaped.

7. The pneumatic tire according to claim 1, wherein the land area is a block sectioned by a circumferential groove extending in the tread circumferential direction and a transverse groove crossing the circumferential groove, or a rib sectioned by the circumferential groove.
